(19) United States
(12) Patent Application Publication
(10) Pub. No.: US 2010/0317328 A1
(43) Pub. Date: Dec. 16, 2010

(54) MOBILE COMMUNICATIONS DEVICE WITH EVENT LOGGING

(75) Inventor: Ofer Halevi, Middlesex (GB)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: Symbian Software Limited, London (GB)

(21) Appl. No.: 12/376,881

(22) PCT Filed: Aug. 7, 2007
(86) PCT No.: PCT/GB07/03011

§ 371 Date: Aug. 27, 2010

(30) Foreign Application Priority Data
Aug. 9, 2006 (GB) 0615844.8

(51) Int. Cl. H04W 4/02

(52) U.S. Cl. 455/414.1

(57) ABSTRACT

This invention relates to a mobile communications device programmed to provide logging of telephony activity. In one implementation, the programme provides near real-time notification and control of mobile phone calls. The notification is to a back-end logging system.

### FIELD OF THE INVENTION

This invention relates to a mobile communications device programmed to provide logging of phone call activity. In one implementation, the programme provides near real-time notification and control of mobile phone calls. The notification is to a back-end logging system.

Current mobile telephones typically include a log of incoming and outgoing phone calls, generally indicating which incoming calls were answered and which were missed.

Many mobile telephones also offer users a function to automatically divert all incoming calls to voicemail, without ringing.

Techniques are also known for barring outgoing phone calls to certain destinations, such as high-rate phone lines.

It is desirable to provide a phone call monitoring and logging system that provides enhanced control of call activity and enhanced logging capabilities, to enable functions to be automated and to improve a user's experience.

### SUMMARY

In accordance with a first aspect of the present invention there is provided a mobile communications device programmed with: (a) a telephony events monitoring agent, registered with a telephony API provided by an operating system of the device so as to receive notifications of any telephony related events; (b) a call handling agent for processing telephony events received from the telephony events monitoring agent and arranged to communicate with the telephony API based on a configured call handling policy, the call handling agent being arranged to store logs of device telephony activity; (c) a communications agent that uses a communications API of the operating system to communicate the logs stored by the call handling agent to a back-end logging system using available communications means provided by the communications API.

In accordance with a second aspect of the invention there is provided a method of enabling a mobile communications device to log calls, comprising the steps of: (a) a telephony events monitoring agent registering with a telephony API provided by an operating system of the mobile device in order to receive notifications of any telephony related events; (b) a call handling agent processing telephony events received from the telephony events monitoring agent and arranged to communicate with the telephony API based on a configured call handling policy, the step of processing including storing logs of device call activity; (c) a communications agent using a communications API of the operating system to communicate the logs stored by the call handling agent to a back-end logging system using available communications means provided by the communications API.

In accordance with a third aspect of the invention there is provided a system for enabling mobile device calls to be logged, the system comprising multiple mobile communications devices as defined above and a back-end logging system arranged to receive logs from the mobile devices.

Preferred features of the invention are set out in the dependent claims.

### DESCRIPTION OF DRAWINGS

The invention will now be described by way of example with reference to the accompanying drawing, in which:

FIG. 1 shows a call handling arrangement including a back-end logging system.

### DETAILED DESCRIPTION

Embodiments of the present invention enable a mobile communications device to intelligently control the handling of calls and telephony events, by reporting telephony events to a logging system and implementing a call handling policy using that logging system. A call handling agent receives input from a telephony events monitoring agent, and the call handling agent communicates with a telephony API of the device to enforce a policy for handling calls and telephony events.

In the preferred embodiment, a method is provided by which 1) telephony events on mobile devices (e.g. making and receiving calls, conferencing, missed calls) can be reported to a back-end logging system (which also receives logs from landline telephones), and 2) telephony activities on the device can be controlled based on a dynamic policy (call barring for outgoing and incoming calls, call cost control, etc.).

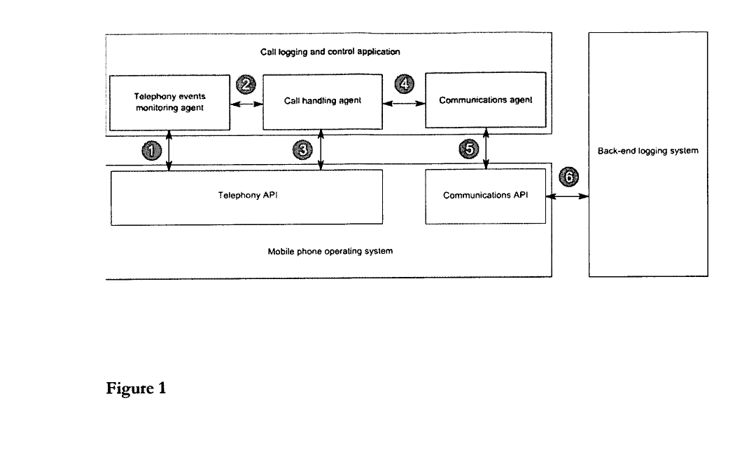

The following series of steps explains how an embodiment of the invention can be used on a mobile telephone. The steps are illustrated in FIG. 1.
1) The “Telephony events monitoring agent” registers with the mobile phone operating system's Telephony API in order to receive notifications of any telephony related events:
   a. Outgoing call;
   b. Incoming call;
   c. Call status change—dialling, answering, connecting, ringing, connected, hanging up, hold, etc.
2) The “Telephony events monitoring agent” notifies the “Call handling agent” of telephony events received from the Telephony API.
3) The “Call handling agent” processes messaging events received from the “Telephony events monitoring agent” and responds to the Telephony API based on configured policy. Call handling policy may cover the following functions:
   a. Log outgoing phone call and content;
   b. Log incoming phone call and content;
   c. Automatically answer incoming calls;
   d. Automatically disconnect incoming calls;
   e. Automatically disconnect outgoing calls;
   f. Determine response based on dynamic properties including message content or properties, date, time, location (GSM network location and/or GPS), phone call origin or destination, associated contact information (in business contacts group or personal contacts group, etc.), diary information, selected profile, etc.;
   g. Capture additional state information such as network information (network name, GSM country, area and cell, signal level), device status (memory consumption, battery level, selected profile);
   h. Determine schedule for communicating log information to the “Back-end logging system” (after each call event, every specific amount of time, at specific times, once a specific amount of log information has been captured, etc.);
   i. Invoke alternative communications client on device (e.g. automatically disconnect outgoing phone call and invoke voice-over-IP client to initiate call).
4) The “call handling agent” communicates call logging information to the “Communications agent” based on scheduling policy. Information may be augmented with additional device information such as device identification (IMEI, IMSI), network information (network type and identification, country, area and cell information). The “Communications agent” notifies the “Call handling agent” of any call handling policy modification requests received from the “Back-end logging system”.
5) The “Communications agent” uses the mobile phone operating system's communications API to communicate with the “Back-end logging system” using available communications means provided by the communications API:
   a. A TCP/IP communication protocol (HTTP, FTP, SMTP, etc.)
   b. A GSM communication channel such as SMS, MMS.
6) The “Back-end logging system” may control the “Message handling agent” policy by communicating policy modifications using available communications means via the “Communications agent”.

The back-end logging system is preferably provided remotely from the device. In this arrangement, the relatively small quantity of storage memory available on current mobile phones need not be impacted by the logged telephony data. Large quantities of storage memory can be provided on remote servers without reducing the available storage on the mobile device. However, it is possible to implement an embodiment of the invention in which the back-end logging system is provided in the device itself. Such an arrangement would have certain advantages: for example, the time taken for data or instructions to be transferred between the logging system and the communications agent could be much shorter.

The communication between the communications agent on the mobile telephone and the logging system preferably involves delivering all recent events logged by the call handling agent to the logging system, and then deleting them from the call handling agent's local log. Once received at the back-end logging system, the recent events are compared with those already stored at the logging system, and updates are made accordingly.

The call handling policy defines the manner in which calls and telephony events are dealt with in the mobile device. It includes a series of rules which specify what should be done in particular circumstances or in response to a particular event. It can be used to control the content of the logging system, the disconnection of certain phone calls, the transition of a call between different states, or any other activity relating to telephony on the device.

In the case where the back-end logging system is used to direct the call handling policy, it could feed back to either the telephony API or the communications agent. It could formulate and modify policy based on criteria such as the amount of storage space available for storing new telephony information, the communication networks available to the device or the battery level. It could also be capable of receiving input from a user in order that the user can influence policy decisions. Alternatively it may be preferred that the user cannot access the back-end logging system, since making it directly accessible from the application level could represent a security risk—malicious or malfunctioning applications could potentially obtain or modify information from the logging system, thereby compromising the user's personal call information.

In the preferred embodiment the call handling policy is enforced at the call handling agent, which receives directions from the communications agent. The call handling agent communicates directly with the Telephony API in order to implement aspects of the call handling policy; however, the call handling agent could alternatively communicate with the API indirectly, via the telephony events monitoring agent or another element. In one embodiment, a user of the device can define at least some aspects of the call handling policy by means of interaction with the call handling agent, either directly or indirectly.

The scheduling policy defines the manner in which data is passed to the back-end logging system. It can define the type of information provided to the back-end logging system, as well as the timing of transmissions to the logging system. The scheduling policy could be determined on a dynamic basis according to the usage of the device's telephony applications. For example, when the device is being used frequently for calls—perhaps during a weekday while the user is away from his office—the communication to the back-end logging system could be performed relatively frequently, whereas during a period of low usage—perhaps during a weekday while the user is at his office desk and primarily using his office phone and computer to send and receive communications—the communication to the back-end logging system could be performed infrequently. This variation in scheduling policy could be achieved by the use of a usage monitoring or prediction agent arranged to determine the current or likely telephony behaviour of the device.

In the preferred embodiment, all of the agents described above—the telephony events monitoring agent, the call handling agent, the communications agent, and the usage monitoring agent—are provided as a single call logging and control application. Alternatively, the logging and control aspects could be provided by separate applications, or some or all of the functionality could be provided within the operating system.

A simple example of the operation of the call logging and control arrangement of the present invention will now be given.

A user of a mobile telephone makes an outgoing call to an overseas destination. The telephony events monitoring agent receives a notification from the Telephony API indicating that a call has been made, and indicating the time of the call and the destination phone number. The call handling agent is informed of this call handling event by the telephony events monitoring agent. The call handling agent stores the outgoing call as an event in a store of recent events: an entry is made in the store to include the nature of the event (outgoing phone call), the time of the call and the number to which it is directed.

At this time, the call handling agent does not communicate back to the Telephony API since no action needs to be taken by the Telephony API in response to this event.

The mobile telephone in the example is currently configured to alert a user when the duration of an outgoing overseas or premium rate call has exceeded ten minutes, in order to warn the user of potentially expensive calls. This configuration has been selected by the user, and could be switched off or altered if preferred. This policy setting is invoked by means of the back-end logging system, with which the user can communicate by password access to change his call handling policy.

In accordance with this policy setting, the call handling agent begins a timer when the new outgoing call is connected. After ten minutes, the call handling agent triggers the Telephony API to cause an alert to be sent to the user in the form of an audible notification. The user can then choose whether to terminate the call and avoid excessive costs.

The scheduling policy in force for the mobile telephone is fixed, and requires that all telephony events stored by the call handling agent are transmitted to the back-end logging system at midnight every day. Thus, at midnight on the day the user made his overseas call, the communications agent retrieves the new entry in the call handling agent's store and sends it over a GSM network to a remote back-end logging system.

It can be seen from the above description that the present invention provides a flexible technique for controlling and logging telephony activity on a mobile device. It will be understood by the skilled person that alternative implementations are possible, and that various modifications of the methods and implementations described above may be made within the scope of the invention, as defined by the appended claims.

1. A mobile communications device programmed with:
(a) a telephony events monitoring agent, registered with a telephony API provided by an operating system of the device so as to receive notifications of any telephony related events;
(b) a call handling agent for processing telephony events received from the telephony events monitoring agent and arranged to communicate widi the telephony API based on a configured call handling policy, the call handling agent being arranged to store logs of device telephony activity;
(c) a communications agent that uses a communications API of the operating system to communicate the logs stored by the call handling agent to a back-end logging system using available communications means provided by the communications API.

2. The device of claim 1 in which the telephony related events include one or more of:
a) Making an outgoing call;
b) Receiving an incoming call;
c) Call status change, where the statues include dialling, answering, connecting, ringing, connected, hanging up, hold, missing a call.

3. The device of claim 1 in which the configured policy includes one or more of the following:
a) Log outgoing call information;
b) Log incoming call information;
c) Automatically answer incoming calls;
d) Automatically disconnect incoming calls;
e) Automatically disconnect outgoing calls;
f) Determine response based on dynamic properties including date, time, location, call origin or destination, associated contact information, diary information, or selected profile;
g) Capture additional state information such as network information or device status;
h) Determine schedule for communicating log information to the back-end logging system;
i) Invoke alternative communications client on device.

4. The device of claim 1 in which the call handling agent communicates call logging information to the communications agent based on a scheduling policy.

5. The device of claim 4 in which the call logging information may be augmented with additional device information such as device identification or network information.

6. The device of claim 1 in which the communications agent notifies the call handling agent of any call handling policy modification requests received from the back-end logging system.

7. The device of claim 1 in which the available communications means provided by the communications API includes one of:
a) A TCP/IP communication protocol (HTTP, FTP, SMTP, etc.)
b) A GSM communication channel such as SMS, MMS.

8. The device of claim 1, arranged such that the back-end logging system can dynamically control the call handling policy by communicating policy modifications to the call handling agent using available communications means via the communications agent.

9. A method of enabling a mobile communications device to log calls, comprising the steps of:
(a) a telephony events monitoring agent registering with a telephony API provided by an operating system of the mobile device in order to receive notifications of any telephony related events;
(b) a call handling agent processing telephony events received from the telephony events monitoring agent and arranged to communicate with the telephony API based on a configured call handling policy, the step of processing including storing logs of device call activity;
(c) a communications agent using a communications API of the operating system to communicate the logs stored by the call handling agent to a back-end logging system using available communications means provided by the communications API.

10. A system for enabling mobile device calls to be logged, the system comprising multiple mobile communications devices as claimed in claim 1 and a back-end logging system arranged to receive logs from the mobile devices.

11. The system of claim 10 in which the back-end logging system is also arranged to log telephone calls received from mobile telephone and from landline calls.
